(19) United States
(12) Patent Application Publication
(10) Pub. No.: US 2025/0100438 A1
(43) Pub. Date: Mar. 27, 2025

(54) RAMP DOOR COVER FOR RECREATIONAL VEHICLES AND RELATED METHODS

(71) Applicant: MORRYDE INTERNATIONAL, INC., Elkhart, IN (US)

(72) Inventors: Ryan Mason, Niles, MI (US); Darrell Byers, Topeka, IN (US); Michael Caster, Elkhart, IN (US)

(21) Appl. No.: 18/895,872

(22) Filed: Sep. 25, 2024

Related U.S. Application Data
(60) Provisional application No. 63/540,512, filed on Sep. 26, 2023.

(51) Int. Cl. B60P 3/34

(52) U.S. Cl. CPC B60P 3/343

(57) ABSTRACT

An assembly for a recreational vehicle having a door frame and a ramp door movable to provide access to an interior of the recreational vehicle includes a cover coupled to the recreational vehicle to be movable between a storage position disposed within the interior of the recreational vehicle and a use position extending over the ramp door with the ramp door in an open state. The cover maintains a planar configuration in the storage position, the use position, and moving between the storage position and the use position.

This application claims the priority benefit of U.S. Provisional Application No. 63/540,512, filed Sep. 26, 2023, the entire contents of which is incorporated by reference herein in its entirety.

### FIELD OF THE DISCLOSURE

The present disclosure generally relates to recreational vehicles and, more particularly, to awnings for recreational vehicles.

### BACKGROUND

Toy hauler recreational vehicles (“RV”) use ramp style doors to load and unload additional vehicles into a rearward compartment. When the ramp door is not closed for travel or being used as a loading ramp it may be used as a patio. Often legs extending from the door or cables may support the door parallel to the ground on which the RV is parked. Using the structure of the ramp door is advantageous because the ramp door is necessarily sturdy enough to support the weight of other vehicles being driven over the door. Therefore, it is possible to have an extremely rigid and safe patio system that minimizes additional weight to the RV.

### SUMMARY

In accordance with a first aspect, an assembly for a recreational vehicle having a door frame and a ramp door movable to provide access to an interior of the recreational vehicle is provided herein. The assembly includes a cover having a planar configuration. The cover is coupled to the recreational vehicle to be movable between a storage position disposed within the interior of the recreational vehicle and a use position extending over the ramp door with the ramp door in an open state. The cover maintains the planar configuration in the storage position, the use position, and moving between the storage position and the use position.

In some examples, the cover can include a rigid outer frame and a material extending within the outer frame or the cover can be a rigid panel. In further examples, the cover can be at least one of waterproof or sun-blocking.

In some examples, the assembly can include a hinge assembly coupled between the cover and the door frame, where the hinge assembly allows the cover to pivot between the storage and use positions. In this example, the cover is disposed in a vertical orientation within the interior of the recreational vehicle in the storage position. In further examples, the hinge assembly can include a pair of U-shaped hinge members, each hinge member having a first end coupled to an interior surface of the door frame and a second end coupled to the cover; the hinge assembly can include a piano hinge having a first end coupled to a lower surface of the door frame and a second end coupled to the cover; and/or the assembly can include one or more lift assist arms coupled between the cover and the door frame to aid a user in moving the cover.

In some examples, the assembly can include rails extending along an interior of the recreational vehicle, where the cover is coupled to the rails such that the cover can be slid out from the interior of the recreational vehicle to the use position and slid into the interior of the recreational vehicle to the storage position. In further examples, the door frame can define a slot opening extending therethrough and the cover can be slidable through the slot opening.

In some examples, the assembly can include one or more side walls configured to releasably couple to the cover in the use position to extend downwardly towards the ramp door. In further examples, the assembly can include a railing extending along edges of the ramp door and the side walls can extend between the cover and the railing.

Any of the above examples can include one or more of the following: the assembly can include a seal extending along a proximal edge of the cover that is configured to sealingly engage the door frame with the cover in the use position; the cover can be sized to extend over at least 75% of the ramp door in the use position; the cover can be sized to extend over at least 95% of ramp door; the assembly can include support rods configured to support the cover in the use position; and/or the assembly can be provided in combination with the recreational vehicle.

In accordance with a second aspect, a method is provided that includes opening a ramp door of a recreational vehicle, moving a cover coupled to the recreational vehicle from a storage position disposed within an interior of the recreational vehicle to a use position extending over the ramp door, and moving the cover from the use position to the storage position, where the cover maintains a planar configuration in the storage position, the use position, and while moving between the storage position and the use position.

In some examples, moving the cover from the storage position to the use position and moving the cover from the use position to the storage position can include pivoting the cover about a hinge assembly coupled between the cover and a door frame of the recreational vehicle or sliding the cover along rails coupled to the recreational vehicle. In further examples, the method can include aiding pivoting of the cover with one or more lift assist arms coupled between the cover and the door frame and/or pressing a seal extending along a proximal edge of the cover against a door frame of the recreational vehicle.

Any of the above examples can include bracing a distal end of the cover with support rods and/or releasably coupling one or more side walls to the cover in the use position.

### BRIEF DESCRIPTION OF THE DRAWINGS

FIG. 1 is a perspective view of a first example assembly for a recreational vehicle having a ramp door and a cover showing the cover in a use position in accordance with various embodiments.

FIG. 2 is a side view of the assembly of FIG. 1 showing side walls coupled to the cover in the use position.

FIG. 3 is a front perspective sectional view of the assembly of FIG. 1 showing a hinge and a hydraulic arm for the cover.

FIG. 4 is a rear perspective sectional view of the assembly of FIG. 1 showing the hinge and the hydraulic arm for the cover.

FIG. 5 is a perspective view of the assembly of FIG. 1 showing a patio railing assembly in a use configuration on the ramp door and the cover in the use position in accordance with various embodiments.

FIG. 6 is a perspective view of the assembly of FIG. 1 showing the cover and a patio railing in a storage position.

FIG. 7 is a side cross-sectional view of the assembly of FIG. 6.

FIG. 8 is a side elevational view of a second example assembly for a recreational vehicle having a ramp door and a cover showing side walls coupled to the cover in the use position in accordance with various embodiments.

FIG. 9 is a side elevational view of the assembly of FIG. 8 showing the cover in a storage position.

### DETAILED DESCRIPTION

Assemblies as described herein provide a rigid, planar cover for a ramp door of a recreational vehicle (“RV”) to create a covered usable space, such as for a patio. The assembly advantageously has a compact storage configuration, which minimizes the interior space of the RV occupied by the rigid cover and maximizes the interior space remaining for storage of other items.

As utilized herein, the cover having a planar configuration can refer to the cover extending entirely within a common plane or can include slight variations from entirely planar, such as to direct rain or other debris to the front and/or side(s) of the cover. For example, planar can be considered to include a cover having an overall height when viewed horizontally less than about five times a thickness of the cover or less than about three times a thickness of the cover. Alternatively, planar can be considered to include a cover having an overall height when viewed horizontally of less than about 8 inches or, more specifically, less than about 5 inches or, more specifically, less than about 3 inches. In these examples, the cover can have small curvature/arcuate configuration or include one or more segments that extend at a small angle (e.g., between 1 degree and 5 degrees or less than 3 degrees) across at least a portion thereof. The cover can have a peak extending longitudinally across a middle (e.g., center) location of the cover with lateral sides of the cover directed at least partially downwardly to direct rain or other debris to the sides of the cover. In another example, the cover can have a peak extending laterally across the rear or middle portion thereof with a front of the cover directed at least partially downwardly to direct rain or other debris to the front of the cover.

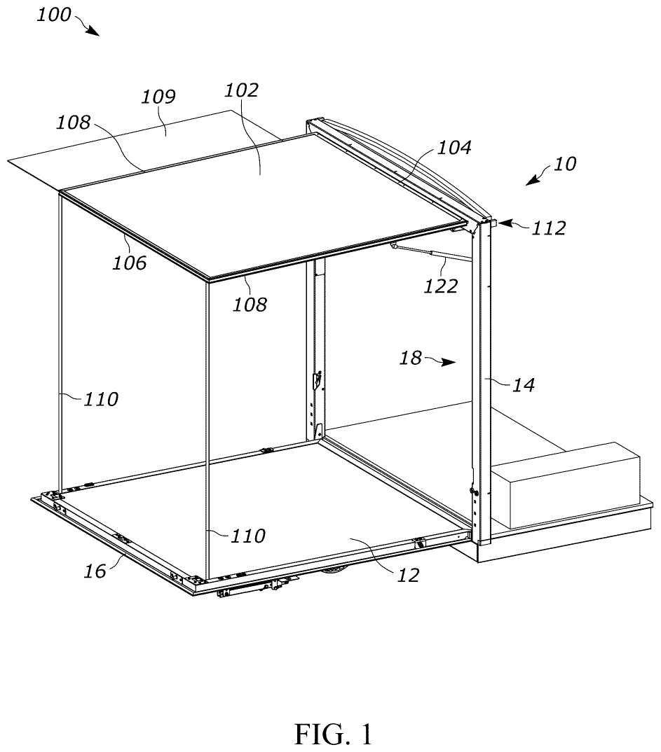

As shown in the figures, a recreational vehicle 10 (not shown in its entirety) (“RV”) includes a ramp door 12 that is pivotably mounted within a door frame 14 of the RV 10. The ramp door 12 can be pivoted between from a generally vertical, closed position extending within the door frame 14 to a ramp position where a top edge 16 of the ramp door 12 contacts the ground to enable objects to be easily loaded into and unloaded from an interior 18 of the RV 10. As shown in FIG. 1, the ramp door 12 can also have a suspended or supported position over the ground surface where the ramp door 12 is held in a generally horizontal position by jack stands (not shown) and/or cables (not shown) attached to the door frame 14. It will be understood that other suitable methods can be utilized to support the ramp door 12 over the ground surface. With the ramp door 12 held in the generally horizontal position, the ramp door 12 can be utilized as a patio or work space. In some examples, the RV 10 can be a towable trailer or a motorized unit.

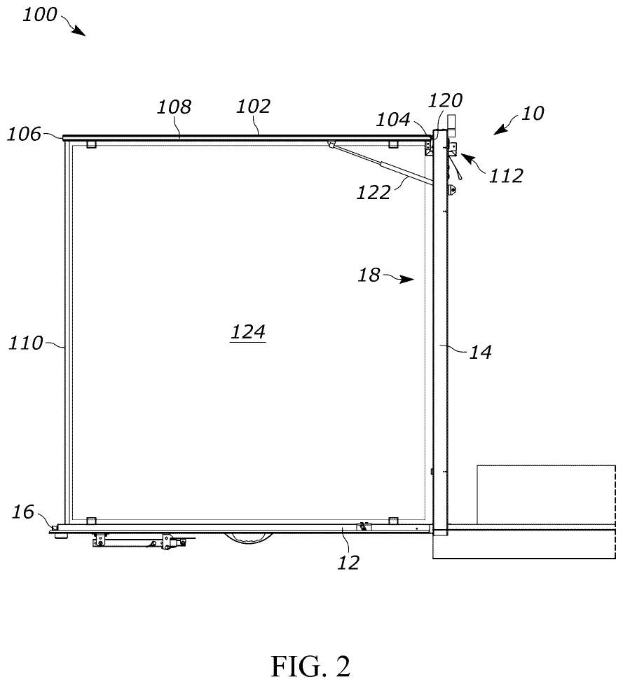

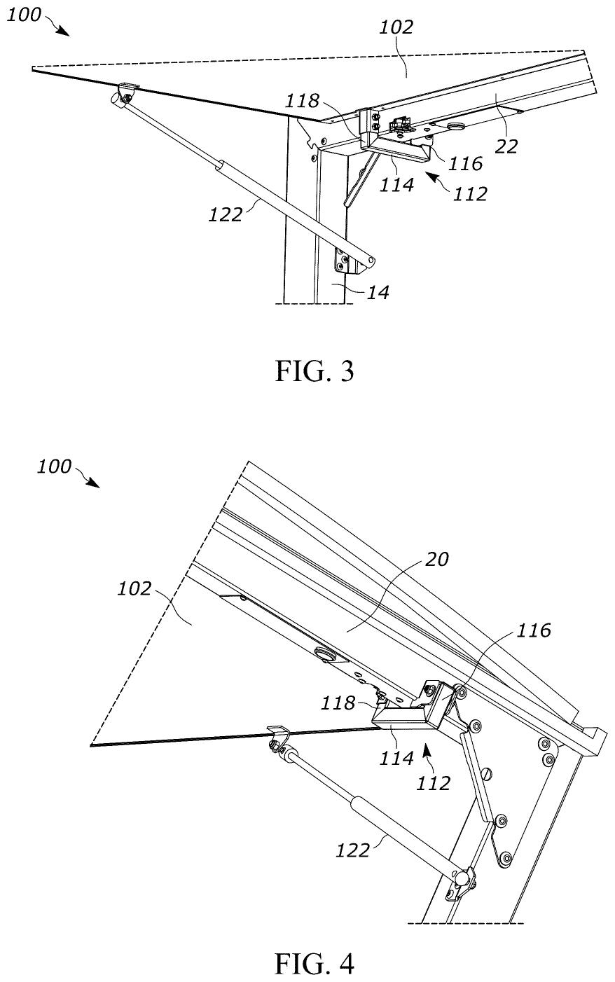

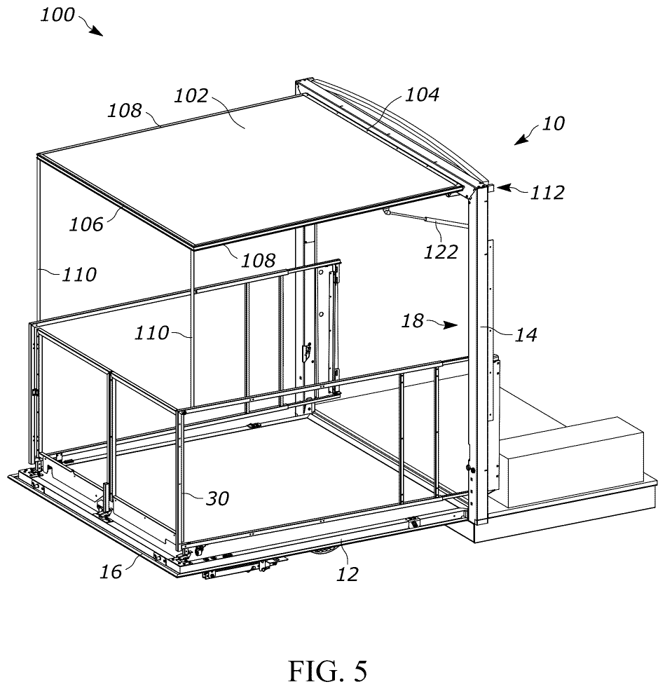

Details of example cover assemblies 100, 200 are shown in FIGS. 1-9. The cover assemblies 100 each include a cover 102, 202 coupled to the door frame 14 to be movable between a storage position disposed within the interior 18 of the RV 10 and a use position extending over the ramp door 12 with the ramp door 12 in an open position. In the use position, the cover 102, 202 can have a generally horizontal orientation. As used herein, generally horizontal includes extending parallel with a longitudinal axis of the RV 10, as well as angled downwardly relative to the longitudinal axis (e.g., between 0 degrees and 20 degrees, between 0 degrees and 15 degrees, between 0 degrees and 10 degrees, between 0 degrees and 5 degrees, etc.) as the cover 102, 202 extends away from the RV 10. For example, a small downward angle can help direct water flow off a distal end of the cover 102, 202.

As shown, the cover 102, 202 has a planar configuration (i.e., the entirety of the cover 102, 202 extends within a plane). For example, the entirety of the cover 102, 202 can be flat to extend rearwardly from the RV 10 in the use position. Further, in some examples, the cover 102, 202 maintains the planar configuration in the storage position, the use position, and moving between the storage position and the use position. In other words, the cover 102, 202 is not bent to while in storage, in use, or when moving between the storage and use positions. Pursuant to this, the cover 102, 202 can be a rigid panel or have an outer rigid frame with material extending within the frame to hold the cover 102, 202 in the planar configuration.

In other examples, the cover 102, 202 can include one or more hinges 103 extending thereacross, such that the cover 102, 202 can be folded (e.g. in half, thirds, quarters, etc.) for storage. The one or more hinges 103 can extend across a width of the cover 102, 202. With this configuration, the cover 102, 202 can be moved to the storage position in the planar configuration and subsequently folded into a compact configuration. This can be used, for example, to provide access to the RV interior 18 underneath the cover 102 when stored in a vertical orientation within the RV 10.

In a first form, the cover 102, 202 can be entirely made from a rigid panel or combination of rigid materials secured together, such as plastic, metal, and so forth. In a second form, the cover 102 can have an outer frame made from a rigid material and a flexible material (e.g., fabric, plastic, etc.) can extend within the outer frame. In some examples, the cover 102, 202 can include an interior span that is solid (e.g., without openings). In other examples, the cover 102, 202 can include an interior span that is a screen or has another mesh/lattice configuration.

The interior span of the cover 102, 202, whether rigid or flexible, can be configured to at least partially block sunlight. For example, the interior span of the cover 102, 202 can have a material thickness, screen thickness, and/or tint to block a percentage of sunlight. The percentage of sunlight can be any suitable percentage, such as 10%, 20%, 30%, 40%, 50%, 60%, 70%, 80%, 90%, or 100%. The cover 102, 202 can be configured to provide UV protection. In some examples, the cover 102, 202 can be waterproof or water resistant.

In the illustrated example, the cover 102, 202 has a rectangular shape with a proximal edge 104, 204, a distal edge 106, 206, and side edges 108, 208 extending between the proximal edge 104, 204 and the distal edge 106, 206. For example, the proximal edge 104, 204 is disposed adjacent to the door frame 14 in the use position and the distal edge 106, 206 is spaced from the door frame 14 in the use position.

The cover 102, 202 can be sized (e.g., have a length and width) to extend over any desired percentage of the ramp door 12. For example, in the use position, the cover 102, 202 can extend over at least 50% of the ramp door 12, at least 75% of the ramp door 12, or at least 95% of the ramp door. Further, the cover 102, 202 can have the same or substantially the same width as the ramp door 12.

In some examples, the cover assemblies 100, 200 can include one or more extension members (e.g., extension member 109 shown in FIG. 1) that are movable with respect to the cover 102, 202 to extend over portions of the ramp door 12 not covered by the cover 102, 202 in the use position or extend past edges of the cover 102, 202 to provide additional coverage. For example, the extension members 109 can be configured to extend from one or both of the side edges 108, 208, and/or from the distal edge 106, 206. The extension members 109 can be pivotably (e.g., by hinges or the like) or slidably coupled to the cover 102, 202. Alternatively, the extension members 109 can be releasably coupled to the cover 102, 202 by snap-fit connectors, fasteners, and so forth.

In some examples, the cover assemblies 100, 200 can also include one or more support rods 110, 210 that are configured to extend from the cover 102, 202 to support structure. The support structure can be the ramp door 12 or a railing, as described in more detail below. The support rods 110, 210 can be removably coupled to the cover 102, 202, such as by snap-fit, threading, fasteners, hook-and-loop fasteners, brackets, and so forth. Alternatively, the support rods 110, 210 can be pivotably mounted to the cover 102, 202 and configured to be stored alongside the cover 102, 202 in the storage position.

The support rods 110, 210 can be disposed anywhere the cover 102, 202 would benefit from additional support. For example, the cover assembly 100, 200 can include support rods 110, 210 at ends of the distal edge 106, 206 of the cover 102, 202 and or along one or more intermediate locations of the side edges 108, 208. In another example, the support rods 110, 210 could extend from a structure of the RV 10, such as the door frame 14.

As discussed above, the cover 102, 202 is coupled to the RV 10 to be movable with respect thereto between the storage and use positions. The cover 102, 202 can couple to the RV 10 in any suitable way.

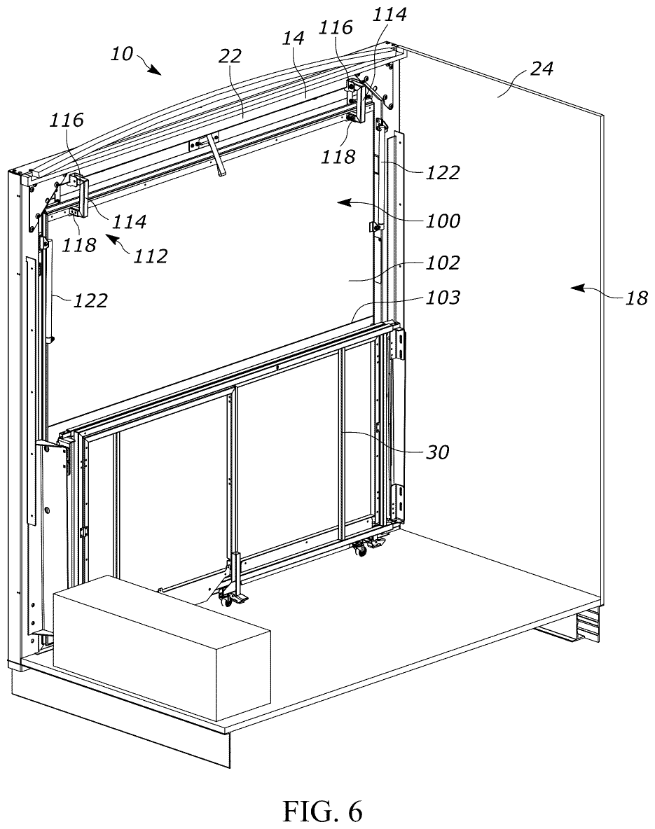

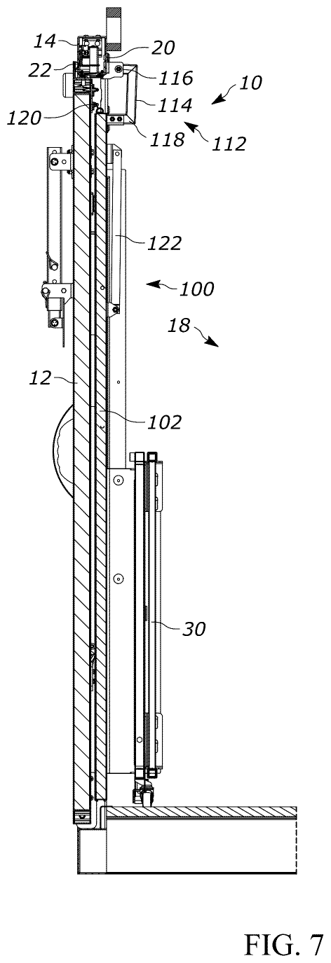

In a first example, as shown in FIGS. 1-7, the cover 102 can be pivotably coupled to the door frame 14 by a hinge assembly 112. The hinge assembly 112 is coupled between the cover 102 and the door frame 14 and allows the cover 102 to pivot between the storage and use positions. With this configuration, the cover 102 is disposed in a vertical orientation within the interior 18 of the RV in the storage position adjacent to the ramp door 12 as shown in FIGS. 6 and 7. As shown, in the storage position, the ramp door 12 and the cover 102 extend closely along one another to minimize used space in the interior 18 of the RV 10.

The hinge assembly 112 can include two or more U-shaped hinge members 114, each with a first end 116 pivotably coupled to the door frame 14 and a second end 118 fixed to the cover 102. In other words, the second end 118 of the hinge member 114 does not move with respect to the cover 102. As shown, the first end 116 is pivotably coupled to an interior surface 20 of the door frame 14 and the U-shape of the hinge member 114 allows the hinge member 114 to pivot under and around the door frame 14 to position the proximal edge 104 of the cover 102 adjacent to an exterior surface 22 of the door frame 14.

In another example, the hinge assembly 112 could include one or more piano hinges secured between a lower surface of the door frame 14 and the cover 102 that allow the cover 102 to pivot from a vertical orientation in the storage position and a generally horizontal orientation in the use position. In other examples, the hinge assembly 112 can include other types of hinges, such as pin-type or 4-link style hinges.

In some examples, a seal 120 can be secured or otherwise coupled to the proximal edge 108 of the cover 102, such that when the cover 102 is pivoted to the use position, the seal 120 sealingly engages the exterior surface 22 of the door frame 14. With this configuration, the seal 120 can effectively prevent or minimize any water or other material from flowing between the cover 102 and the RV 10 with the cover 102 in the use position. As shown in FIG. 7, the seal 120 can be formed from a flexible material (e.g., rubber, plastic, etc.) to have a hemispherical cross-section. The seal 120 can be hollow as shown to easily conform to the door frame 14 when pressed against the door frame 14 in the use position. The seal 120 can also include an outwardly projecting rib as shown that projects upwardly along the door frame 14 to direct water away from the door frame 14.

In some examples, the assembly 102 can include one or more lift assist arms 122 that extend between the cover 102 and the door frame 14 that aid a user in moving the cover 102 between the storage and use positions. As shown, the arms 122 can be mounted to an interior surface of the door frame 14 to allow the cover 102 to have a vertical orientation when in the storage position. The arms 122 can be any suitable mechanism, including hydraulic arms, actuator arms, spring assist arms, and so forth.

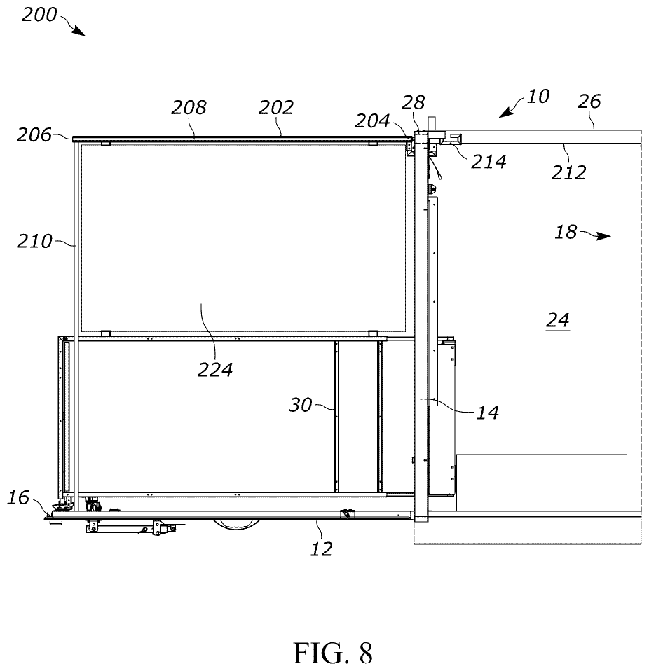

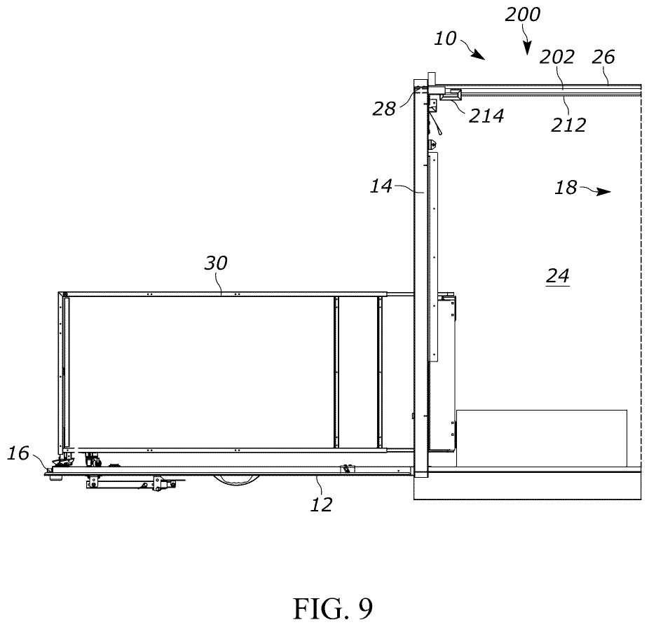

In a second example, as shown in FIGS. 8 and 9, the cover 202 can be slidably coupled to the RV 10. For example, the RV 10 can include rails 212 that extend along a sidewall 24 or a roof 26 of the RV 10 and the cover 202 can be slidably coupled to the rails 212. With this configuration, the cover 202 can be slid horizontally between the storage and use positions and, as such, always have a generally horizontal orientation. As shown, in the storage position, the cover 202 extends along the roof 26 (e.g., with main faces of the roof 26 and cover 202 facing one another) of the RV 10, which advantageously maximizes lower usable space within the RV interior 18.

The sliding action of the cover 202 can be facilitated in a number of ways. For example, the rails 212 can incorporate bearings or have a lubricant or low friction material disposed thereon. Alternatively, the rails 212 can be made from a low friction material. Similarly, either in addition to the features of the rails 212 or alternatively thereto, the cover 202 can include a low friction material or coating for at least the portion engaged by the rails 212 or the cover 202 can have bearings, wheels, or rollers coupled thereto to allow the cover 202 to roll within the rails 212.

The rails 212 can be mounted below a height of the top of the door frame 14, such that the cover 202 can be slid underneath the door frame 14 between the use and storage positions. Alternatively, the door frame 14 or the rear wall of the RV 10 can define a slot opening 28 that extends therethrough and the cover 202 can be slidable through the slot opening.

To hold the cover 202 in the use and/or storage position, a latch 214 can be resealably engaged to the cover 202 and/or rails 212 to prevent relative movement between the cover 202 and the rails 212. The latch 214 can utilize any suitable mechanism, including snap-fit connectors, magnets, pins, fasteners, and so forth.

In some examples, such as to minimize weather impact on the patio, one or more sidewalls 124, 224 can be releasably coupled to the cover 102, 202 when the cover 102, 202 is in the use position to extend downwardly from one or more edges 104, 204, 106, 206, 108, 208 thereof to create partial or full sidewalls for the patio. For example, the sidewalls 124, 224 can extend downwardly from the cover 102, 202 to releasably couple to the ramp door 12. The sidewalls 124, 224 can be continuous to wrap around the cover 102, 202 or can be discrete to be added as needed.

Similar to the cover 102, 202, the sidewalls 124, 224 can be wind-proof, waterproof, water resistant, sun-blocking, etc. Additionally or alternatively, if desired, the sidewalls 124, 224 can include or be formed from screens to allow air flow, while keeping bugs or other pests out. Further, the sidewalls 124, 224 can include shades (e.g., collapsible or rollable) to selectively cover the screens. The sidewalls 124, 224 can connect to the cover 102, 202 by any suitable mechanism, including, for example, hook-and-loop fasteners, snap-fit connectors, hooks, magnets, and so forth.

In some examples, the RV 10 can include a railing 30 to extend along side and distal edges of the ramp door 12 when the ramp door 12 is in the horizontal, open state. The railing 30 can be pivotably coupled to the RV 10, such as the door frame 14, and movable from a storage position folded within the RV interior 18 and a use position. Example railings are disclosed in U.S. Pat. No. 10,479,428, issued Nov. 19, 2019, and U.S. application Ser. No. 17/572,765, filed Jan. 11, 2022, which are both hereby incorporated by reference herein in their entireties. Other suitable railings can also be used in conjunction with the cover 102, 202. For example, some railings that pivotably connect to or fold down onto the ramp door 12. With any of these configurations, the sidewalls 124, 224 and/or the support rods 110, 210 can be configured to releasably couple to the railing 30 to extend between the cover 102, 202 and the railing 30.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

The singular forms “a”, “an”, and “the” are intended to include the plural forms as well, unless the context indicates otherwise. The terms “comprises”, “includes”, “has”, and the like specify the presence of stated features, steps, operations, elements, components, etc., but do not preclude the presence or addition of one or more other features, steps, operations, elements, components, or groups.

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An assembly for a recreational vehicle having a door frame and a ramp door movable to provide access to an interior of the recreational vehicle, the assembly comprising:
a cover having a planar configuration, the cover coupled to the recreational vehicle to be movable between a storage position disposed within the interior of the recreational vehicle and a use position extending over the ramp door with the ramp door in an open state;
wherein the cover maintains the planar configuration in the storage position, the use position, and moving between the storage position and the use position.

2. The assembly of claim 1, further comprising a hinge assembly coupled between the cover and the door frame, the hinge assembly allowing the cover to pivot between the storage and use positions, the cover being disposed in a vertical orientation within the interior of the recreational vehicle in the storage position.

3. The assembly of claim 2, wherein the hinge assembly comprises:
at least two U-shaped hinge members, each hinge member having a first end coupled to an interior surface of the door frame and a second end coupled to the cover; or
a piano hinge having a first end coupled to a lower surface of the door frame and a second end coupled to the cover.

4. The assembly of claim 1, further comprising one or more lift assist arms coupled between the cover and the door frame to aid a user in moving the cover.

5. The assembly of claim 1, further comprising rails extending along an interior of the recreational vehicle, the cover coupled to the rails such that the cover can be slid out from the interior of the recreational vehicle to the use position and slid into the interior of the recreational vehicle to the storage position.

6. The assembly of claim 5, wherein the door frame defines a slot opening extending therethrough, the cover slidable through the slot opening.

7. The assembly of claim 1, wherein the cover comprises a proximal edge, a distal edge, and side edges extending between the proximal edge and the distal edge, and further comprising a seal extending along the proximal edge of the cover, the seal configured to sealingly engage the door frame with the cover in the use position.

8. The assembly of claim 1, further comprising at least one of:
support rods configured to couple to the cover to support the cover in the use position; or
one or more side walls configured to releasably couple to the cover in the use position to extend downwardly towards the ramp door.

9. The assembly of claim 8, further comprising a railing extending along edges of the ramp door, the at least one of: the support rods or the side walls extending between the cover and the railing.

10. The assembly of claim 1, wherein the cover comprises a rigid outer frame and a flexible material extending within the outer frame.

11. The assembly of claim 1, wherein the cover is a rigid panel.

12. The assembly of claim 1, wherein the cover is sized to extend over at least 75% of the ramp door in the use position.

13. The assembly of claim 1 in combination with the recreational vehicle.

14. A method comprising:
opening a ramp door of a recreational vehicle;
moving a cover coupled to the recreational vehicle from a storage position disposed within an interior of the recreational vehicle to a use position extending over the ramp door; and
moving the cover from the use position to the storage position;
wherein the cover maintains a planar configuration in the storage position, the use position, and while moving between the storage position and the use position.

15. The method of claim 14, wherein moving the cover from the storage position to the use position and moving the cover from the use position to the storage position comprises pivoting the cover about a hinge assembly coupled between the cover and a door frame of the recreational vehicle.

16. The method of claim 15, further comprising aiding pivoting of the cover with one or more lift assist arms coupled between the cover and the door frame.

17. The method of claim 14, wherein moving the cover from the storage position to the use position and moving the cover from the use position to the storage position comprises sliding the cover along rails coupled to the recreational vehicle.

18. The method of claim 14, wherein moving the cover to the use position comprises pressing a seal extending along a proximal edge of the cover against a door frame of the recreational vehicle.

19. The method of claim 14, further comprising bracing a distal end of the cover with support rods.

20. The method of claim 14, further comprising releasably coupling one or more side walls to the cover in the use position.
